(19) United States
(12) Patent Application Publication
(10) Pub. No.: US 2010/0099293 A1
(43) Pub. Date: Apr. 22, 2010

(54) ELECTRICAL CONNECTOR WITH HIGH PROFILE CONTACTS

(75) Inventors: GAO-BING LEI, Shenzhen (CN); NAN HU, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/501,023

(22) Filed: Jul. 10, 2009

(30) Foreign Application Priority Data
Oct. 22, 2008 (CN) 200820186355.4

(51) Int. Cl. H01R 4/50

(52) U.S. Cl. 439/345

(57) ABSTRACT

An electrical card connector includes: an insulating housing having a mounting surface, a mating surface and a pair of sidewalls between the mounting surface and the mating surface; a plurality of contacts retained in the insulating housing. The contact has a base portion retained in the insulating housing, a contacting beam extending upwardly from the base portion for protruding on the mating surface, a connecting portion downwardly extending from the base portion and a soldering portion formed on a tip end of the connecting portion. The contact further includes a retaining beam connected with the connecting portion and extending inwardly for locking the connecting portion without moving outwardly, which can provide a stable and right position for the connecting portion and prevent the connecting portion from disengaging away from the passageway outwardly.

### BACKGROUND OF THE INVENTION

1. Field of the Invention

The present invention relates to an electrical card connector, and more particularly to an electrical card connector with contacts of high profile.

2. Description of Related Art

An electrical card connector is used in an electronic device for connecting with a card. The electrical connector usually includes an insulating housing, a plurality of contact retained in the insulating housing and a shell covering on the insulating housing. The insulating housing defines a mating surface mating with an electrical card, a mounting surface mounted on a PCB (printed circuit board). Said contact includes a base portion, a contacting portion extending from the base portion upwardly and located on the mating surface for contacting with the electrical card, and a soldering leg extending from the base portion outwardly. Sometimes, the height of the insulating housing needs be increased to meet different demands, which increases the distance between the mating surface and the mounting surface of the insulating housing. As a result, the vertical length of the contact will be increased, and the soldering leg may fail to keep in a right position before the electrical card connector is soldering on the PCB.

So it is necessary to provide a new electrical card connector to solve the problems above.

### SUMMARY OF THE INVENTION

Accordingly, it is an object of the present invention to provide an electrical card connector which can keep the soldering portion of the contact in a right position before mounted on a PCB.

In order to achieve above-mentioned object, an electrical card connector is provided and comprises: an insulating housing having a mounting surface, a mating surface and a pair of sidewalls between the mounting surface and the mating surface; a plurality of contacts retained in the insulating housing. The contact has a base portion retained in the insulating housing, a contacting beam extending upwardly from the base portion for protruding on the mating surface, a connecting portion downwardly extending from the base portion and a soldering portion formed on a tip end of the connecting portion. The contact further includes a retaining beam connected with the connecting portion and extending inwardly for locking the connecting portion without moving outwardly.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of the electrical card connector in accordance with the present invention;

FIG. 2 is another perspective view of the electrical card connector of FIG. 1 from a bottom view;

FIG. 3 is an exploded perspective view of the electrical card connector of FIG. 2; and

FIG. 4 is a partial exploded perspective view of the electrical card connector of FIG. 1 before the shell is assembled onto the insulating housing.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

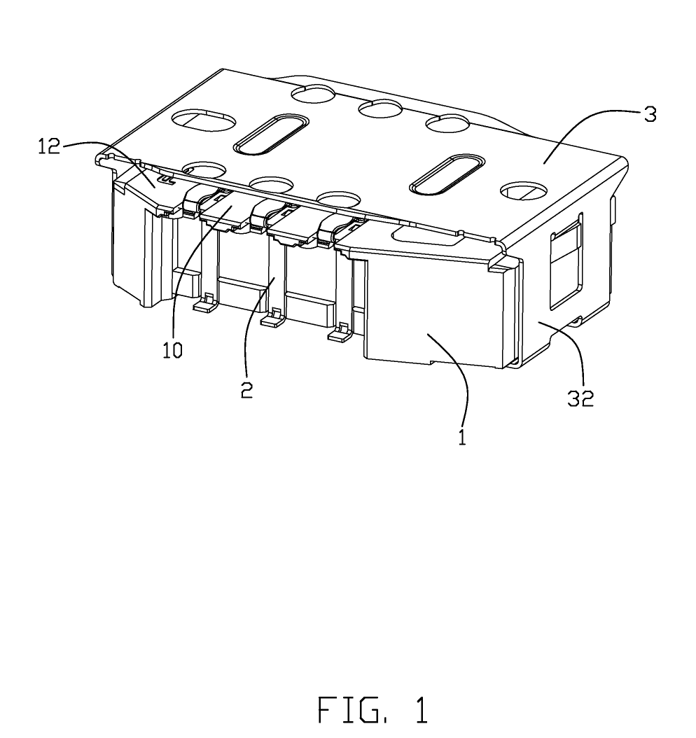

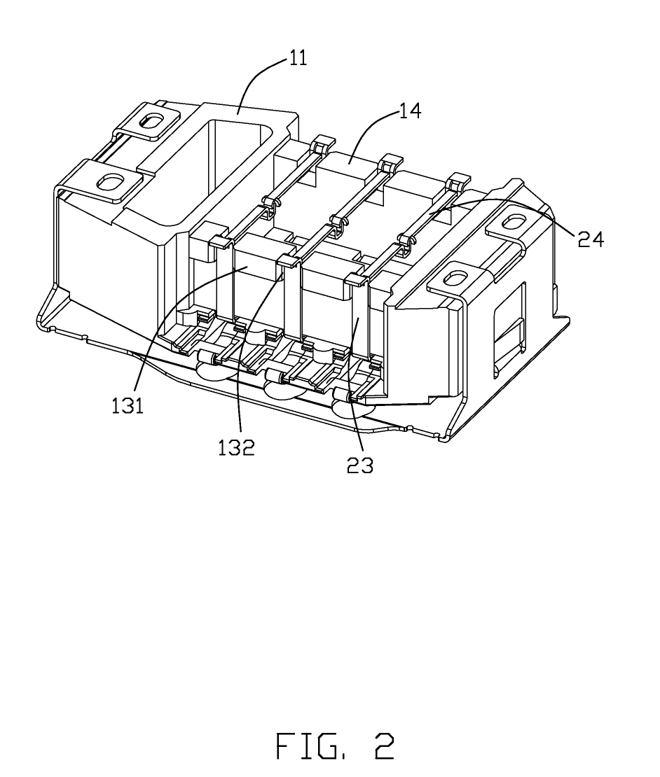

Referring to FIGS. 1 to 2, an electrical card connector used for receiving an electrical card includes an insulating housing 1, a plurality of contacts 2 retained in the insulating housing 1 and a shell 3 assembled on the insulating housing 1 and defining a card receiving room for receiving the electrical card.

The insulating housing 1 defines a mounting surface 11 mounted on a PCB, a mating surface 12 parallel to the mounting surface 11, and a pair of sidewalls 13 connecting with said mounting surface 11 and said mating surface 12. The sidewall 13 is formed inwardly and depressed compared with two ends of the insulating housing 1 to be arranged with two sets of the contacts 2. Referring to FIG. 2, the sidewall 13 defines a plurality of separated edge portions 121 protruding outwards at two sides of the mating surface 11. Each two adjacent protruding edge portions defines a receiving groove 120 therebetween for retaining said contact 2. A plurality of projections 131 are formed at two sides of the mounting surface 11 corresponding to the edge portions 121 respectively. Each two adjacent projections 131 define a passageway 132 therebetween.

As referring to FIG. 2, the contact 2 includes a horizontal base portion 21 retained in the receiving groove 120, a contacting beam 22 bending outwards from the base portion and extending onto the mating surface 12 of the insulating housing 1, a connecting portion 23 extending downwardly from the base portion 21 abutting against on an outer surface of the sidewall 13, and a retaining beam 24 projecting inwardly from a lower portion of the connecting portion 23. Said base portion 21 engages with said edge portions 121 and is securely retained in the receiving groove 120 along a vertical direction. The contacting beam 22 protrudes into the card receiving room from the mating surface 12 for mating with the electrical card. Said lower portion of connecting portion 23 is retained in the passageway 132 with a tip end bended outwardly to form a soldering portion 231. The connecting portion 23 is clamped by the projections 131 in order to avoid shaking of the contact 2. The passageway 132 further runs through the sidewall 13 inwardly to receive the retaining beam 24. The retaining beam 24 is connected with said lower portion of the connecting portion 23 by Laser Welding Technology and extending inwardly with an engaging portion 241 formed on a tip end thereof. The contacts 2 are divided into two sets arranged on two opposite sides of the sidewall 13 respectively. Said retaining beams 24 in each pair of the contacts 2 extends toward each other and has an engagement between the engaging portions 241. As a result, the connecting portion 23 fails to disengage from the passageway 132 outwardly, which makes the connection between said connecting portion 23 and the insulating housing 1 much more stable, meanwhile, the soldering portion 231 of the contact 2 can be located in a right and stable position before the electrical card connector is soldered onto the PCB. The retaining beam 24 is formed by metal and covered by insulating material on the surface thereof so that the engagement between each pair of contacts cannot lead into a short.

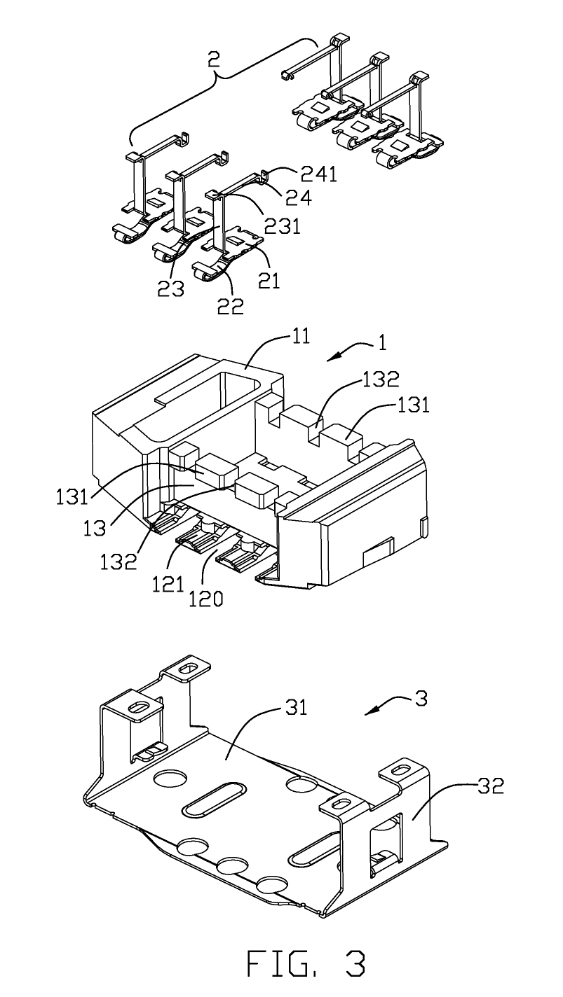

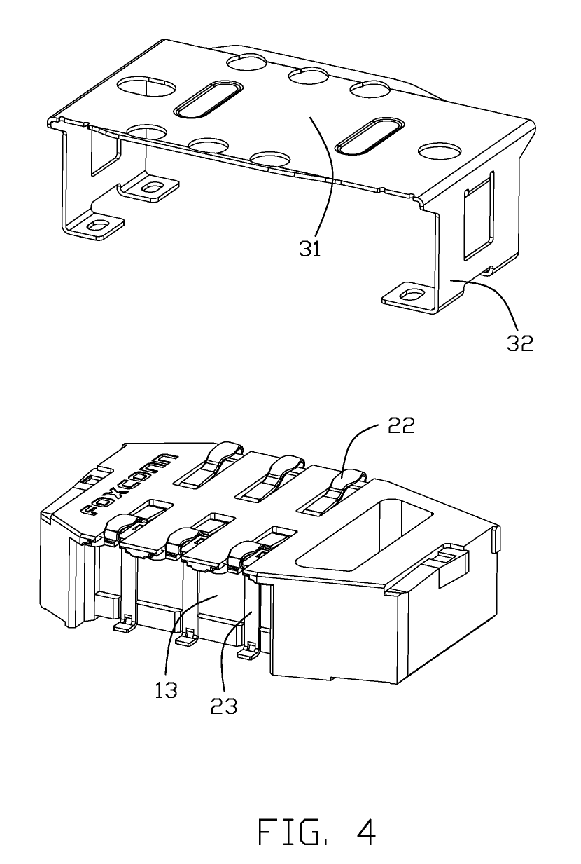

In FIGS. 3 and 4, the shell 4 is assembled onto the insulating housing 1 downwardly and includes a top covering portion 31 covering upon the mating surface 12 of the insulating housing 1, and a pair of retaining arms 32 extending downwardly from two ends of said covering portion 31 for engaging with the insulating housing 1.

In other embodiment, the engagement between two retaining beams 24 in each pair of contacts 2 can be replaced in another way, for example, the retaining beam 24 can also extend inwardly and engage with a structure of the insulating housing 1 which can also provide a stable and right position for the connecting portion 23 and prevent the connecting portion 23 from disengaging away from the passageway 132 outwardly.

However, while the preferred embodiment of the invention have been shown and described, it will apparent to those skilled in the art that changes and modifications may be made therein without departing from the spirit of the invention, the scope of which is defined by the appended claims.

What is claimed is:

1. An electrical connector comprising:
an insulating housing having a mounting surface, a mating surface and a pair of sidewalls between said mounting surface and said mating surface;
a plurality of contacts retained in said insulating housing, said contact having a base portion retained in the insulating housing, a contacting beam extending from the base portion and protruding on the mating surface, a connecting portion downwardly extending from the base portion and a soldering portion formed on a tip end of the connecting portion; wherein
said contact further includes a retaining beam connected with said connecting portion and extending inwardly to lock the connecting portion without moving outwardly.

2. The electrical connector as claimed in claim 1, wherein the contacts are divided into two sets, the two sets are located on two sides of said insulating housing respectively and has an engagement between the two retaining beams.

3. The electrical connector as claimed in claim 1, wherein every two contacts retained on two sidewalls respectively engages with each other by the retaining beams.

4. The electrical connector as claimed in claim 1, wherein said retaining beam extends into the insulating housing and has an engaging portion at a tip end thereon.

5. The electrical connector as claimed in claim 4, wherein said retaining beam is connected with a lower portion of the connecting portion which is adjacent to the soldering portion.

6. The electrical connector as claimed in claim 5, wherein the retaining beam is connected with the connecting portion in way of laser welding.

7. The electrical connector as claimed in claim 6, wherein the soldering portion of the contact is bended horizontally from the connecting portion and extends outwardly from the sidewalls.

8. The electrical connector as claimed in claim 1, wherein the retaining beam is covered by insulating material on the surface thereof.

9. The electrical connector as claimed in claim 8, wherein the connecting portion is arranged on an outer surface of the sidewall and vertically extends to the mounting surface of the insulating housing.

10. The electrical connector as claimed in claim 9, wherein the sidewall defines a plurality of passageways for retaining a lower portion of the connecting portion horizontally.

11. An electrical connector comprising:
an insulating housing having a mounting surface and a mating surface parallel to the mounting surface;
a plurality of contacts retained in two opposite side of the insulating housing, each contact comprising:
a base portion retained in the insulating housing adjacent to the mating face, a contacting beam protruding to the mating surface, a connecting portion abutting against the side of the housing and a soldering portion parallel to the mounting surface and a retaining beam; wherein
the retaining beam and the soldering portion are connecting with the connecting portion and extend in opposite direction.

12. The electrical connector as claimed in claim 11, wherein the retaining beams of every two contacts on opposite sides of the housing respectively engage with each other to prevent outward-movement of the connecting portion.

13. The electrical connector as claimed in claim 12, wherein the soldering portions bend outwardly from the connecting portion and the retaining beams are soldered to the connecting portion.

14. An electrical connector comprising:
an insulative housing defining opposite mounting surfaces and mating surfaces;
plural pairs of contacts disposed in the housing, each of said pair of contacts including:
a base portion;
a downwardly deflectable contacting portion extending from the base portion and above the mating surface;
a soldering portion located on the mounting surface and linked to the base portion via a connection portion;
an engagement beam electrically and mechanically engaged with another engagement beam of the other contact of the same pair.

15. The electrical connector as claimed in claim 14, wherein said engagement beam is directly linked to the corresponding connection portion.

16. The electrical connector as claimed in claim 15, wherein said base portion retains the contact to the housing.

17. The electrical connector as claimed in claim 14, wherein the engagement beam and the contacting portion extend opposite to each other in a top view.

18. The electrical connector as claimed in claim 14, wherein a side wall of the housing defines a recess above which a free end of the contacting portion is located.

19. The electrical connector as claimed in claim 14, wherein said connection portion essentially extends along a side wall of the housing vertically.

20. The electrical connector as claimed in claim 14, wherein said engagement beam extends along the mounting surface horizontally.
